(19) United States
(12) Patent Application Publication
(10) Pub. No.: US 2004/0104858 A1
(43) Pub. Date: Jun. 3, 2004

(54) Wide band slot cavity antenna

(76) Inventors: Markus Pfletschinger, Eningen (DE); Martin Kuhn, Stuttgart (DE)

Correspondence Address: Mark Ungerman, Fulbright & Jaworski, 801 Pennsylvania Avenue, Washington, DC, 20004-2623, US

(21) Appl. No.: 10/467,658

(22) PCT Filed: Nov. 13, 2002
(86) PCT No.: PCT/EP02/12692

(30) Foreign Application Priority Data
Dec. 15, 2001 (DE) 10161722.4

(51) Int. Cl. H01Q 1/32

(52) U.S. Cl. 343/713

(57) ABSTRACT

The invention related to an antenna (1), especially a vehicle antenna for use in mobile telephony. In order to achieve a compact, especially flat and short construction, said antenna is configured as a radiating open hollow cavity resonator with a specially designated wide band slot (7,8).

The invention relates to an antenna, especially a motor vehicle antenna for mobile telephony, as claimed in the features of the preamble of claim 1.

DE 199 22 699 A1 discloses an antenna, preferably a motor vehicle antenna for mobile telephony. In this antenna there are vertical radiators as radiating structures which are located on a ground surface and are interconnected via an impedance transformation line. As a result of tuning (especially length) of the vertical radiators and the impedance transformation line for the intended frequency range, especially in the mobile telephony range from 0.8 to 2.2 GHz, this known antenna has given length and height dimensions. Since this antenna is integrated underneath the rear window of the motor vehicle, due to its geometrical dimensions it requires a large installation space which is either not available or reduces the interior of the motor vehicle in an undesirable manner. Another disadvantage is that a coaxial cable for signal transmission is soldered directly to the ground surface, the inner lead of the coaxial cable being connected to the impedance transformation line. This yields a complex structure which especially has the disadvantage that before installation of the antenna there is a cable tail which poses problems in handling the prefabricated antennas before their installation.

Therefore the object of the invention is to make available an antenna, especially a motor vehicle antenna for mobile telephony, with which the initially mentioned disadvantages are avoided.

This object is achieved by the features of claim 1.

In the antenna as claimed for the invention, the radiating structures are a conductive area which is open on both sides and which is slit lengthwise to be excited to radiate in several frequency ranges. For this reason it is possible for the antenna to have a compact structure with the same properties, especially for it to be much shorter (by roughly one half) and flatter. Thus the installation space under the rear window or on a roof flange of the motor vehicle can be much better and more efficiently used. Depending on the extent of the frequency range or depending on the frequencies which are to be sent or received the antenna length corresponds roughly to one third of the wavelength of the lowest frequency.

In one development of the invention the conductive area which has been slit lengthwise has a double kink in a partial area. The doubly kinked slot which has, for example, a funnel shape facilitates a very broad band and thus makes the radiator more durable relative to installation tolerances.

In a development of the invention the lengthwise-slit conductive areas together form a slot that tapers to a point. Thus a vertical radiator with a flat structure for the required frequency range or ranges is made easily available.

In a development of the invention another slot which branches especially roughly in the middle proceeds from the slot which tapers to a point and separates the lengthwise-slit conductive areas from one another. Depending on the execution, especially the width and length of the bent slot, the impedance of the antenna can be matched over wide ranges or also over additional ranges. For optimum impedance matching and also for optimum surface utilization, the leg of the bent slot, which leg proceeds from the slot which tapers to a point, is shorter than the slot area adjoining it.

In a development of the invention the areas are shielded in the direction in which emission is not to take place by a housing body, especially a sheet of metal. This metal housing body prevents emission into the interior of the motor vehicle. Depending on the dimensions of the housing body which extends at least over the area of a board, but can also be larger or smaller, at least a significant reduction of emission into the interior of the motor vehicle is accomplished.

In a development of the invention the lengthwise-slit conductive areas are located on a board such as a copper surface. This on the one hand makes available an economical material for producing the vertical radiator of the antenna. On the other hand, it is possible by known methods (for example, etching processes) to leave copper areas on the board, while at least one slot, such as two slots, can be produced by etching away corresponding copper areas. Based on this process it is possible to influence the shape of the areas as well as the shape of the slots in wide, necessary flat areas.

In a development of the invention the branching slot is made such that a direct current short circuit does not occur at the base of the antenna. For this reason, before its installation the antenna can be electrically checked for serviceability and for faults. By preventing a direct current short circuit, only one simple test resistor need be connected in parallel at the feed point. A coupling capacitor which is necessary for conventional slotted radiators can be omitted. This simplifies the structure and reduces costs.

In a development of the invention, there is a contact partner, especially a plug, in the base of the antenna on the board. In this way, during production of the antenna a contact partner already can be provided on the board without the necessity of a cable being provided at the time. For testing the antenna, such a cable can be connected temporarily via the contact partner. After the test the cable can be removed again so that transport and storage of the antenna is simplified up to its final installation. Only with or after installation of the antenna in a vehicle does the corresponding cabling need to take place.

One embodiment of the antenna and its installation are described and explained below using the figures. But here the invention is not limited to the indicated embodiments.

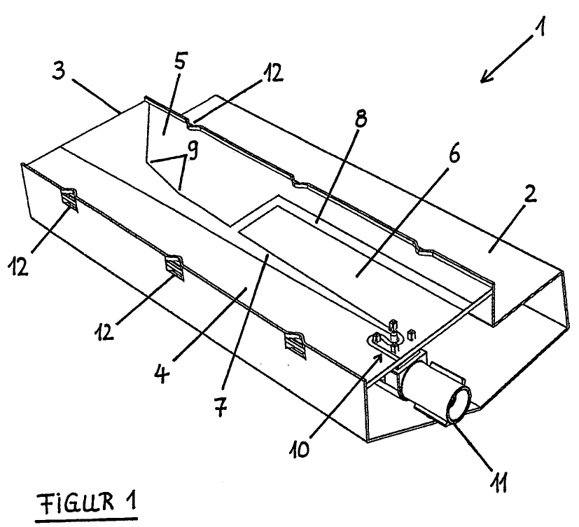

FIG. 1 shows a three-dimensional view of a prefabricated antenna,

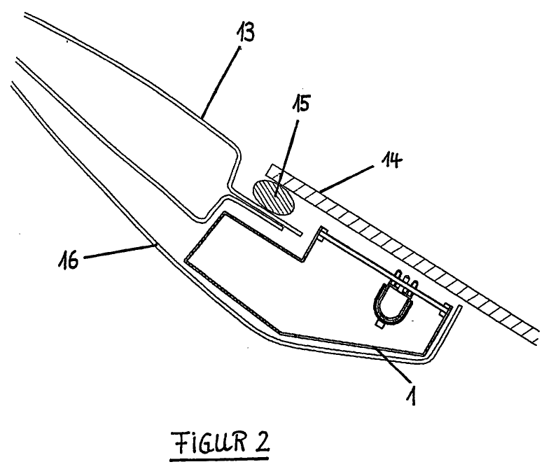

FIG. 2 shows a sectional view of the antenna as shown in FIG. 1 at its installation site.

FIG. 1 shows an antenna 1 for receiving and sending high frequency signals, especially in the mobile telephony domains AMPS, GSM 900/18000, PCS, UMTS and the like. The indicated antenna 1 is especially usable as a motor vehicle antenna, or for other applications, such as static applications also are achievable.

The antenna 1 has a metal housing body which consist of a multiply bent metal sheet 2. Such a bent metal sheet 2 is on the one hand desirable in reducing material costs, and on the other it can be easily and quickly produced. This benefits production of the antenna 1 as claimed in the invention. The corresponding bending of the metal sheet 2 yields two parallel legs spaced apart, with a board 3 located between them. In the conventional manner the board 3 has a base surface which consists of nonconductive material. On this base surface of the board 3 there are several conductive areas 4 to 6 which are produced, for example, by covering the later with conductive areas 4 to 6 and etching away the uncovered intermediate areas. The areas which are etched away form at least one first slot 7 which is formed on one side by the shape of an edge of area 4 and on another side by the shapes of edges of areas 5 and 6. Furthermore, proceeding from this first slot 7 for matching the impedance of the antenna 1 there is a second slot 8 which in turn separates the two areas 5 and 6 from one another. If the second slot 8 is omitted, the two areas 5 and 6 form a continuous area, the second slot 8 extends roughly from the middle of the first slot 7 at a right angle a short distance, then a longer length of the second slot 8 extends roughly parallel to the first slot 7.

In the embodiment of the antenna 1 which is shown in FIG. 1 the conductive area 5 includes double kinks 9. At the base 10 of the antenna 1 there is a contact partner, especially a plug 11, to which a coaxial cable for feeding to and from the antenna 1 can be plugged. In order to be able to attach the board 3 to the housing body, especially the bent metal sheet 2, the legs of the metal sheet 2 which are spaced parallel to one another have several punched-bent areas 12 by which the board 3 is attached to the housing base body. These punched-bent areas 12 have the advantage that they are simple to produce and thus the board 3 can be quickly attached to the housing body 2.

FIG. 2 shows the antenna 1, which is shown in a three-dimensional view in FIG. 1, in a sectional view at an installation site. At an end area of a roof flange 13 of a vehicle which is not further shown a rear window 14 adjoins and is attached to the roof flange 13 by means of cement (cement bead 15). In the area between the window 14 and an inner lining 16 (head liner) is the installation site for the antenna 1 which can be kept especially flat as a result of the configuration of the antenna 1 as claimed in the invention.

The antenna, especially a motor vehicle antenna for mobile telephony, is thus in summary made as a radiating open cavity resonator with a specially executed broadband slot in order to achieve a structure which is as compact, especially flat and short, as possible.

Reference Number List

1. Antenna

2. Housing body

3. Board

4. Conductive area

5. Conductive area

6. Conductive area

7. First slot

8. Second slot

9. Double kink

10. Base

11. Plug

12. Punched-bent area

13. Roof flange

14. Window

15. Cement bead

16. Inside lining

1. Antenna (1), especially motor vehicle antenna for mobile telephony, with radiating means for receiving and sending high frequency signals, characterized in that as the radiating means a conductive area (4 to 6) which is open on both sides and which is slit lengthwise is excited to radiate in several frequency ranges.

2. Antenna (1) as claimed in claim 1, wherein at least one area (5) has a double kink (9).

3. Antenna (1) as claimed in claim 1 or 2, wherein at least the area (4) with the other areas (5, 6) forms a slot (7) which tapers to a point.

4. Antenna (1) as claimed in claim 1, 2, or 3, wherein another slot (8) which branches especially in the middle of the slot (7) proceeds from the slot (7) and separates the areas (5, 6) from one another.

5. Antenna (1) as claimed in one of the preceding claims, wherein the areas (4 to 6) are shielded in the direction in which emission is not to take place, by a metal housing body, especially a bent metal sheet (2).

6. Antenna (1) as claimed in one of the preceding claims, wherein the areas (4 to 6) are arranged as a copper surface on the board (3).

7. Antenna (1) as claimed in one of claims 4 to 6, wherein the branching slot (8) is made such that a direct current short circuit does not occur at the base (10) of the antenna.

8. Antenna (1) as claimed in one of claims 6 or 7, wherein at the base (10) of the antenna (10) on the board (3) there is a contact partner, especially a plug (11).

9. Antenna (1) as claimed in one of claims 6, 7 or 8, wherein the board (3) can be attached to the housing body via punched-bent areas (12).
